(19) United States
(12) Patent Application Publication
(10) Pub. No.: US 2003/0135421 A1
(43) Pub. Date: Jul. 17, 2003

(54) Buyer protection service

(76) Inventors: Shelia F. Cales, Farmersville, OH (US); Danny A. Cales, Farmersville, OH (US)

Correspondence Address: Michael S. Neustel, 2534 South University Drive, Suite No. 4, Fargo, ND, 58103, US

(21) Appl. No.: 10/047,804

(22) Filed: Jan. 14, 2002

(51) Int. Cl. G06F 17/60

(52) U.S. Cl. 705/26; 705/39

(57) ABSTRACT

A method to provide an e-commerce based third party buyer protection service (BPS) to monitor and direct a business transaction between a buyer and seller is provided. The BPS is designed to release a buyer payment to the seller after product acceptance by the buyer or to affect a refund to the buyer when the purchased product is not received or the buyer is dissatisfied with and returns the received product. Buyer determination to return the product may be due to having received the wrong product, shipment damage or the product is not as advertised. The service process begins with an agreement between the buyer and seller to agree to the terms of the BPS policies and directives. The buyer provides transaction information and a buyer payment where the payment is issued to the BPS to be cleared, deposited and held for distribution by the BPS dependent on buyer satisfaction of the product for purchase. Buyer satisfaction of the received product results in the buyer payment, less a BPS service fee, released to the seller. Buyer dissatisfaction results in a return of the buyer payment, less a BPS fee, with confirmation of product return receipt to the seller. This inventive solution guards the buyer against losing a product purchase price due to seller fraud or product mismanagement.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a third party service to monitor and manage the exchange of a buyer payment for a product. More specifically, the present invention provides a method to refund the buyer the purchase price of a product that is not received or determined by the buyer to be unacceptable upon receipt.

2. Description of the Prior Art

Many people enjoy the convenience to select and buy goods and services from the vast, global marketplace offered through the Internet. It is estimated that over 50,000 merchants have set up shop on the Web as of year-end 1999. The investments firm Goldman Sachs estimates that the value of business to business e-commerce conducted in the United States will be approximately 1.5 trillion by 2004, up from an estimated $114 billion in 1999. Better security and simplified payment systems have contributed to the success of e-commerce in recent years.

Web based retail merchants of any size use a number of tools to set up and manage virtual storefronts on the Internet. Such tools typically offer a shipping cart that can be accessed by a Web browser (shopper) followed by a secure method to process credit card payments over the Internet. This payment system takes payment information from Internet clients protected by a 128-bit Secure Sockets Layer (SSL) encryption protocol running concurrently with the Hypertext Transfer Protocol (HTTP), termed Secure Hypertext Transfer Protocol (SHTTP). The secure transmission protocol is recognized to the Web browser in the active browser address as https instead of the usual http as in www.http://merchant.com. Furthermore, the Web browser is often warned when entering and leaving a “secure” area through the usual pop up windows. These systems also enable retailers to add product-related searching, sales tax and audit reports, and discounts and coupons.

Many people engage in the buying and selling of goods and services in a person to person “secondary market”, where the seller is a small business concern or a private individual without a business license. Antiques, camera equipment, stamps, cars, trucks, snowmobiles, rugs etc. are examples of a world of items bought and sold as private sales through Internet auction or classified type Web sites, newspapers and magazines without the expensive retail middle man. Frequently, the buyer and seller are miles apart and conduct the transaction by telephone, through the Internet E-mail or a friend etc. where the buyer and seller must complete the deal through the mail or other long distance method. For these purchases, the buyer may make payment in the form of a check, cashier's check or money order without assurances that the money will be refunded if the buyer is not satisfied with the received product, if received at all. The seller may not be known or have a public reputation for honest, fair business. Payment by credit card provides some purchase protection in that the card provider may be notified to cancel the debit in the case of seller fraud; however, this avenue for restitution is problematic at best requiring documentation and perhaps months to resolve a dispute. Also, few small businesses can afford to support payment by credit card since the credit card services require a percentage fee for each charge. The popular online auction site eBay Inc. provides a person to person trading community on the Internet (www.ebay.com) where buyers and sellers are brought together. With eBay, the seller designates acceptable forms of payment for the product by the successful bidder. The potential bidder (buyer) is made aware of the type of payment and may choose not to participate. Usually, the seller chooses a form of payment that can be readily cashed without fees or delay to assure payment before shipping. Since credit cards providers charge a service fee, they and are not popular to the private low volume seller. This “up front payment” is ideal for the seller but puts the buyer at great risk of losing the payment without a sure means to retrieve the payment in case of seller fraud, shipment damage or dissatisfaction with the product. Despite the feedback and buyer/seller rating system provided through eBay, this payment system depends on the integrity of the buyer and seller. The United States Government has made progress in detecting e-commerce based fraud, but these early efforts do not guarantee or provide the buyer with timely restitution.

FIG. 1A shows a simplified diagram 100 of the well known Internet Web 101. A buyer 103 is shown with connection through an Internet Service Provider (ISP) 102 across a data backbone 109 to another ISP with local connection to a private seller 106. Note that the seller 106 and buyer 103 could reverse roles. Either way, this type of simple private purchase is transacted over the Web by E-mail. The method of exchange of goods for money is generally accomplished without benefit of a sophisticated payment system now used by the big or small retail merchant operating through a virtual storefront. The Bank 104 and Retail Merchant 105 maintain a Web site and are examples of established businesses that operate with the tools to encrypt the transmission of the sensitive private information. The Web browser also provides a private, valid personal identification number PIN to gain access to personal accounts for online banking. The retail merchant expects a credit card number to effect payment and may require a private browser password in addition to the secure transmission to protect the buyer from purchase fraud. Several approaches to improve Internet purchase security are evolving daily. The Internet Web of FIG. 1A also shows connection to an auction type Web site 107, essentially another form of the private seller, where the seller, like the private seller may elect acceptable forms of payment other than and without the minimal form of payment protection by credit card.

In these respects, a buyer protection system according to the present invention substantially departs from the conventional concepts and designs of the prior art, and in so doing provides a method primarily developed for the purpose to provide the buyer with the means to retrieve the pledged purchase funds in the event the product is not received, received damaged or the buyer deems the product unacceptable.

### SUMMARY OF THE INVENTION

In view of the foregoing disadvantages inherent in known methods to protect the buyer in the prior art, the present invention provides a new third party buyer protection service (BPS) to monitor and direct a business transaction between a buyer and seller. The BPS is configured to affect a refund to the buyer when the purchased product is not received or the buyer is dissatisfied and decides to return the product. The buyer may decide to return the product due to shipment damage, have received the wrong product or the received product is not as advertised by the seller. To utilize the BPS, the buyer and seller must first agree to the terms and polices of the service. The process proceeds with receipt of the buyer E-mail with account registration, all necessary transaction information and a buyer payment issued to the BPS. The buyer payment includes the product purchase price, applicable tax and the buyer protection service fee. The service monitors and directs the transaction and, most importantly, holds the buyer payment for distribution to the buyer or seller dependent on direction from the buyer. This inventive solution guards the buyer against losing the payment due to seller fraud or product mismanagement.

It is to be understood that the invention is not limited in its application to the details of construction and to the arrangements of the components set forth in the following description. The invention is capable of other embodiments and of being practiced and carried out in various ways. Also, it is to be understood the phraseology and terminology employed herein are for the purpose of the description and should not be regarded as limiting.

A primary object of the present invention is to provide a buyer protection service that will overcome the shortcomings of the prior art devices.

Another object of the present invention is where both the buyer and seller agree to utilize the inventive third party buyer protection service.

An object of the present invention is to provide a third party buyer protection service that will provide the buyer with a method for a timely refund of the purchase price when the product is not received.

Another object of the present invention is to provide a third party buyer protection service that will provide the buyer with a timely refund of the purchase price when the product is rejected by the buyer and returned to the seller.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1A is a simplified diagram of the Internet showing connection between a buyer and various types of sellers.

FIG. 1B is a simplified diagram of the Internet Web showing the connection between a buyer, private seller and the inventive solution.

FIG. 2 is a block diagram of the protection service apparatus to implement the preferred embodiment of the invention.

FIG. 3 is a block diagram supporting other embodiments of the invention.

FIGS. 4A-4C is a flow chart of the steps to implement the invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital video discs), and computer instruction signals embodied in a transmission medium (with or without a carrier wave upon which the signals are modulated). For example, the transmission medium may include a communications network, such as the Internet.

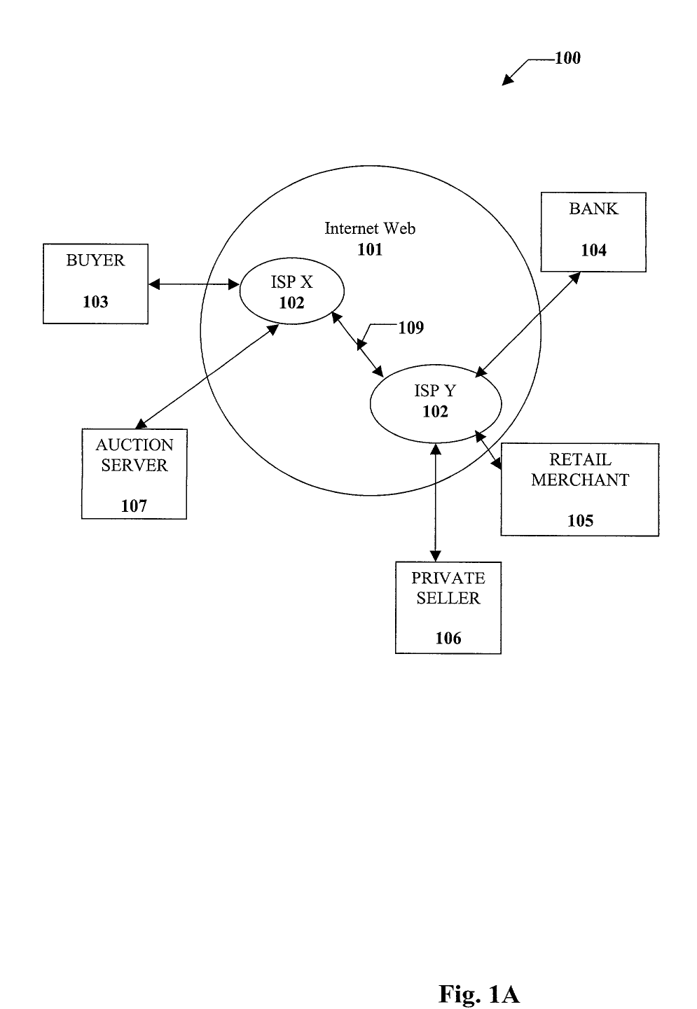

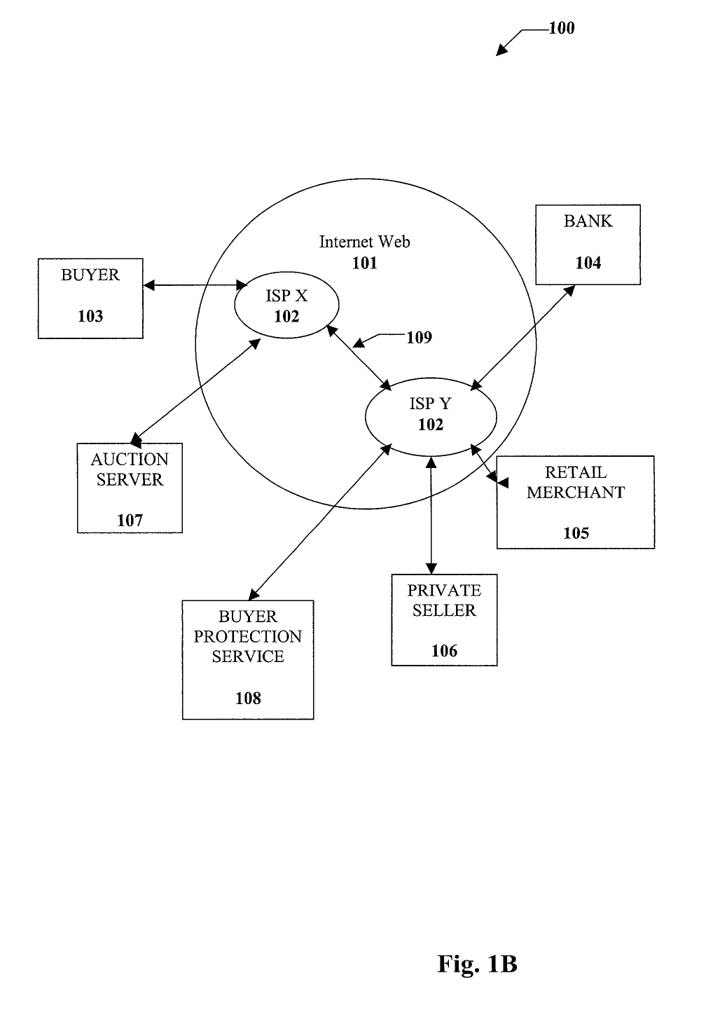

FIG. 1B is a simplified diagram of the Internet Web 101 showing the connection between the buyer 103 and private seller 106, retail merchant 105 and an online Bank 104 with the addition of the buyer protection service (BPS) 108. The BPS shares access to the Web in a manner well known in the art to provide an alternative method of the payment system but with buyer protection between the buyer 103 and the private seller 106, auction Web site 108 or other form of private seller without the inherent problems and limitations of a sophisticated payment system, if any.

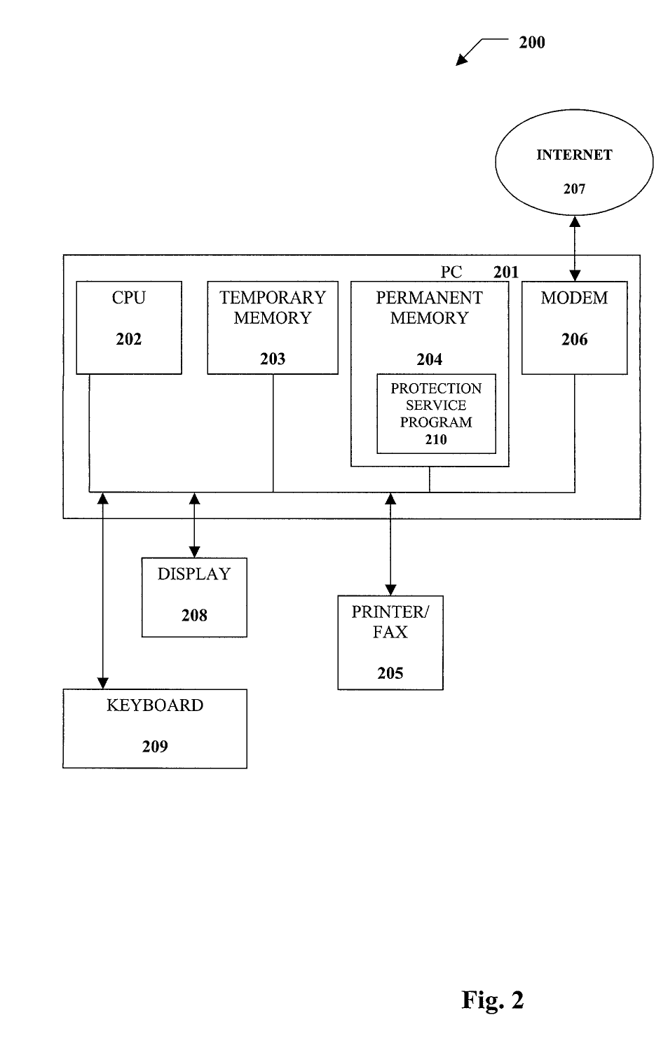

FIG. 2 depicts the preferred embodiment 200 of the buyer protection service of FIG. 1B. The BPS is realized as a personal computing (PC) system 201 with connection to the Internet Web well known in the art. The PC contains a central processing unit (CPU) 202, temporary memory (RAM) 203 to support ongoing active applications and a hard drive 204 with sufficient permanent memory storage to run the inventive protection service program 210 under any popular operating systems. The PC utilizes the usual peripherals including a keyboard 209, display monitor 208, printer/FAX 205 and an interface 206 to connect the PC with an internet service provider 207. The interface may be a dial up type modem or take the form of a cable adapter for a DSL or transceiving satellite dish to link with the ISP.

With reference to FIG. 1B and FIG. 2, the BPS is set up with an Internet Web address such that a BPS operator can exchange E-mail with the service clients. The protection service program 210 provides an organized program for the operator to input client data and manage the various accounts stored on the memory hard drive 204.

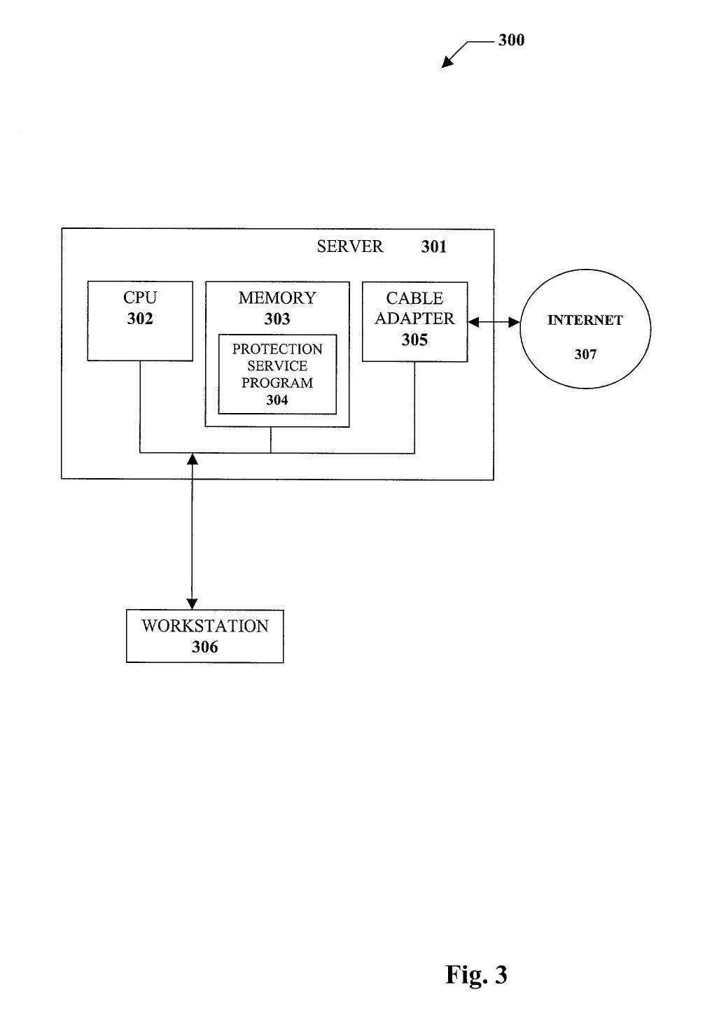

FIG. 3 depicts a second embodiment of the inventive solution 300 which includes a server 301 between the Web and one or a number of workstations 306. The server includes a central processing unit 302, sufficient memory 303 to process client activity and a cable adapter 305 to effect high speed connection to the Internet 307 in methods well known in the art. In this embodiment, the workstation(s) 306 are configured similarly to the PC of the first embodiment but accepts client data through the server so as to simultaneously handle a larger volume of client traffic. The protection service program 304 is structured to perform the account bookkeeping of FIG. 2 as well as the Web access, account firewall and local area network (LAN) functions necessary to the server. The server essentially protects and routes E-mail through multiple workstations where the service is manually conducted by several workstation operators.

In a third embodiment of the inventive solution, the server 301 of FIG. 3 is configured to maintain a BPS Web site, as driven by the protection service program 304 for an alternative interactive and automatic connection between the service, buyer and seller rather than the direct person to person E-mail approach of the first and second embodiments. In this embodiment, the Web site provides individually password protected areas for the buyer, seller and the service to conduct business. The protected area is designed to allow the buyer, seller or BPS operator to log on and input data, respond to client responses, BPS direction or to view the status and history of the E-mail and account activity. The extent of automation of this system is configured by the BPS operator(s) on workstations 306 where the workstations may or may not be physically located with the server.

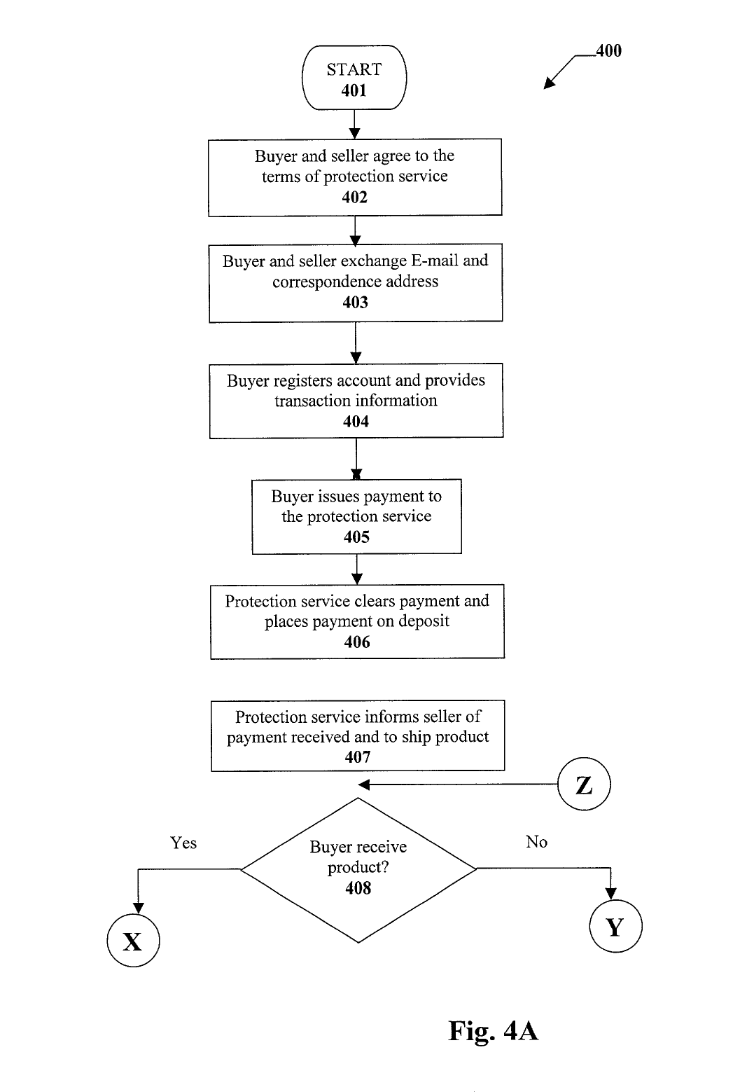

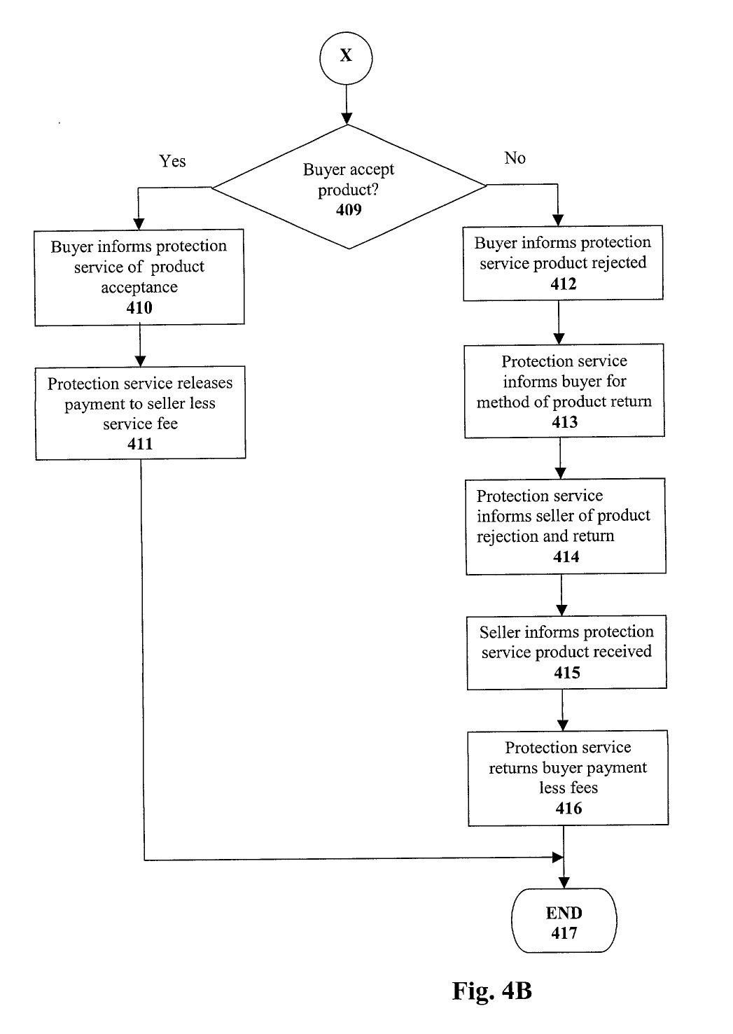

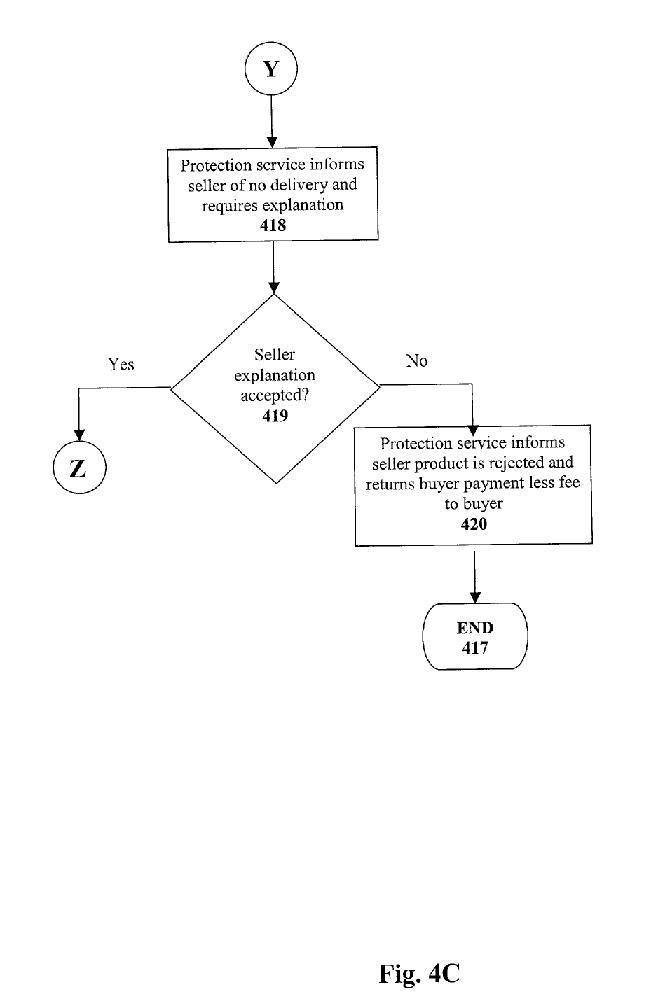

FIGS. 4A-4C show the process steps of the buyer protection service 400. The process begins 401 with an agreement 402 between the buyer and seller to utilize the BPS followed by an exchange 403 of their respective E-mail and correspondence address. With an Internet connection as shown in FIG. 1B, the buyer E-mails the BPS to set up an account followed by the transaction information 404. The transaction information includes:

Buyer name, E-mail and correspondence address

Seller name, E-mail and correspondence address.

Identification of the product to be sold.

Purchase price and applicable tax of the product.

Type of payment—check, money order, credit card or cashier's check.

Alternatively, the private seller may supply the transaction information. Next, the buyer issues payment 405 to the protection service. The payment includes the purchase price of the product, applicable tax, any estimated shipping fees and the buyer protection service fee. A BPS fee table is presented to a prospective client at account registration or other appropriate time. The monetary fee may be established as a flat fee or a percentage of the product purchase price. For example, the fee could be $10 for a purchase price of $300 or less and 6% of a purchase price over $300. With receipt of the payment, the BPS clears and deposits the payment 406 and informs the buyer and seller 407 of payment received and directs the seller to ship the product for prompt delivery. The seller is urged to purchase shipment insurance and to ship the product by registered mail with a return receipt.

If the product is received, the buyer evaluates the product for acceptance 409. As expected, the buyer has undisputed authority to accept or reject the received product. With acceptance, the buyer contacts the BPS to authorize release of the payment 410. The BPS releases payment 411 to the seller less the BPS service fee. The transaction and account is closed 417.

If the buyer rejects the product, the buyer has the responsibility to inform the BPS that the product is rejected 412. This period of buyer evaluation is monitored by the BPS, defined by the return receipt. The BPS service then informs the buyer for the method of product return 413. The duration of the buyer product evaluation period and the method and costs of forward and return shipment are predefined in a service agreement between the buyer and seller as administered by the BPS. Next, the BPS informs the seller of product rejection and return 414. Upon product receipt, the seller informs the BPS that the product is received 415. It is preferred that buyer and seller accept in the agreement terms of the BPS to use shipment insurance and registered mail with return receipt. With the seller notification of receipt, the BPS returns 416 the buyer product payment less BPS fees. The transaction account is closed 417.

If the buyer does not receive the product 408 by a predefined period of time, the BPS informs the seller of a no delivery condition and requests an explanation 418. With an acceptable seller explanation considered by the BPS and buyer, the process returns to the step whether buyer expects to receive the product 408 any follows the process steps previously discussed. With no or unacceptable seller explanation for lack of delivery, the BPS informs the seller that the product is rejected and returns payment less the BPS fee to the buyer 420. The transaction account is closed 417.

It will be appreciated that in general, the inventive product effectively provides the buyer a refund of the purchase price in the event the buyer did not receive the product or is dissatisfied with the received product due to seller fraud or other causes. The inventive product functions as a disinterested third party to insure a secure payment system between a private buyer and private seller.

While specific embodiments of the invention have been described and illustrated, such embodiments should be considered illustrative of the invention only and not as limiting the invention as construed in accordance with the accompanying claims.

We claim:

1. A method for a third party to monitor and direct a business transaction between a buyer and seller comprising:
agreement between a buyer and seller to the terms of a buyer protection service to transact a product purchase;
accept transaction information;
receive buyer payment issued to buyer protection service;
clear payment and place payment on deposit;
inform seller of payment received and to ship product;
monitor for product receipt and buyer evaluation;
determine to release buyer payment to buyer or seller; and
close the transaction.

2. A method as claimed in claim 1 where said agreement, said accept, said inform, said monitor and said close are comprised of communication between the buyer, seller and buyer protection service through the Internet Web e-mail, a buyer protection service operated Internet Web site or a combination of the Internet Web e-mail and buyer protection service operated Internet Web site.

3. A method as claimed in claim 1 where said agreement further comprises defining the method and financial responsibility of a forward or return product shipment with shipment insurance and shipment registration with return receipt.

4. A method as claimed in claim 1 where said transaction information comprises information provided by the buyer or seller.

5. A method as claimed in claim 1 where said transaction information comprises:
buyer name, E-mail and correspondence address;
seller name, E-mail and correspondence address;
identification of the product to be sold;
purchase price and applicable tax of the product; and
type of payment.

6. A method as claimed in claim 1 where said buyer payment comprises the product purchase price, applicable tax and buyer protection service fee.

7. A method as claimed in claim 1 where said determine to release buyer payment further comprises the buyer protection service releases product payment less buyer protection service fee to seller after said buyer informs buyer protection service buyer accepts the received product.

8. A method as claimed in claim 1 where said determine to release buyer payment further comprises:
receives notice from buyer of product rejection;
informs buyer of return method;
informs seller of product rejection and return;
receives notice from seller product return received; and
returns buyer payment less buyer protection service fee to buyer.
